(19) United States
(12) Patent Application Publication
(10) Pub. No.: US 2014/0334462 A1
(43) Pub. Date: Nov. 13, 2014

(54) METHODS, APPARATUSES AND COMPUTER PROGRAM PRODUCTS FOR DETERMINING A RESOURCE INDEX

(71) Applicant: TELEFONAKTIEBOLAGET L M ERICSSON (PUBL), Stockholm (SE)

(72) Inventor: Jose Luis Pradas, Stockholm (SE)

(73) Assignee: TELEFONAKTIEBOLAGET L M ERICSSON (PUBL), Stockholm (SE)

(21) Appl. No.: 14/347,847

(22) PCT Filed: Dec. 20, 2013
(86) PCT No.: PCT/SE2013/051599

§ 371 Date: Mar. 27, 2014

Related U.S. Application Data
(60) Provisional application No. 61/821,034, filed on May 8, 2013.
(60) Provisional application No. 61/825,253, filed on May 20, 2013.

(51) Int. Cl. H04W 72/04

(52) U.S. Cl. CPC H04W 72/0446
USPC 370/336

(57) ABSTRACT

This disclosure provides methods for determining or calculating a default Enhanced Dedicated Channel, E-DCH, resource index, and apparatuses for performing the method. In some embodiments, a method for calculating a E-DCH resource index includes: receiving a Concurrent Transmission Time Interval, TTI, Partition Index, CTPI, and calculating (SigInd+CTPI) mod Y or calculating (SigInd mod (Y−CTPI))+CTPI, where Y is the total number of E-DCH resources configured in a cell for Enhanced Uplink in CELL_FACH state and IDLE mode, and SigInd is the signature index value of the Nth PRACH preamble signature corresponding to an access indicator, AI, that is configured available in the cell and corresponding to E-DCH transmission for Enhanced Uplink in CELL_FACH state and IDLE mode.

### TECHNICAL FIELD

This disclosure relates to methods, apparatuses and computer program products for determining or calculating a default Enhanced Dedicated Channel (E-DCH) resource index.

### BACKGROUND

The 3rd Generation Partnership Project (3GPP) standardized in Release 8 a feature referred to as “Enhanced Uplink in CELL_FACH and Idle mode.” This feature enables a wireless communication device (WCD) (alternatively referred to as User Equipment (UE)) to transmit data on an Enhanced Dedicated Channel (E-DCH) while in Idle Mode or in CELL_FACH state in Connected Mode, see also 3GPP Technical Specification TS 25.319 which gives an overview of the feature. Before the WCD can begin transmitting data using the E-DCH, the WCD must first request access to the network using a random access procedure. This random access procedure includes the WCD selecting an access preamble signature (hereafter “signature”) from a predefined ordered set of signatures and then transmitting to the network (e.g., to a base station) one or more times an access request, which request includes the selected signature or data derived using the signature. In response to receiving the access request and detecting the signature selected by the WCD, the network may send an acknowledgement (ACK) Access Indicator (AI) (e.g., an AI set to +1) on the Acquisition Indicator Channel (AICH). An ACK on the AICH means that the WCD is assigned a default common E-DCH resource that is mapped to the detected signature. That is, there is a one-to-one mapping between available signatures and default common E-DCH resources.

The mapping between the available signatures and the default common E-DCH resources is given by the formula: X=SigInd mod Y, where X is the default E-DCH resource index that identifies the common E-DCH resource mapped to the selected signature, Y is the total number of E-DCH resources configured in the cell for Enhanced Uplink in CELL_FACH state and IDLE mode, and SigInd is an integer (a.k.a., index value) associated with the selected signature.

Accordingly, when the WCD receives the ACK on the AICH in response to the WCD performing the random access procedure, the WCD calculates X so that the WCD will know which default E-DCH resource to use.

### SUMMARY

The inventors have identified a problem with the way in which the WCD determines the common E-DCH resource (i.e., the way in which X is calculated). For example, as explained by the example given below, a problem arises when the WCD requests use of a “partition 2” or “partition 3” (defined below) 2 millisecond (ms) transmission time interval (TTI) common E-DCH resource (i.e., when, as part of the random access procedure, the WCD selects a signature associated with a partition 2 or partition 3 E-DCH 2 ms TTI).

In Release 8, all common E-DCH resources are configured with a unique TTI either 10 or 2 ms TIT. In Release 11, the network may configure common E-DCH resources with 10 ms TTI and common E-DCH resources with 2 ms TTI. This is called concurrent deployment of 10 and 2 ms TTI. To configure concurrent deployment of 2 and 10 ms TTI, the network needs to broadcasts those information elements (IEs) which contain the relevant information to configure the feature in the WCD.

As discussed above, as part of the random access procedure, the WCD selects a signature from a predefined ordered set of signatures. More specifically, the WCD selects a signature from a particular subset of the predefined ordered set of signatures. The particular subset from which the WCD selects a signature depends on the capabilities of the WCD and the capabilities of the network node (e.g., base station) serving the cell in which the WCD is located. More specifically, for example, in Release 11 the predefined ordered set of signatures may be divided into five subsets as shown in the below table:

| | | | | |
|---|---|---|---|---|
| R99 | Rel-8 common | partition 1 | partition 2 | partition 3 |
| Access | E-DCH, 10 ms | Rel-11 | Rel-11 | Rel-11 |
| | | common | common | common |
| | | E-DCH 10 ms | E-DCH 2 ms | E-DCH 2 ms |

Partition 1 is defined in the IE “PRACH preamble control parameters extension list for Type 1 (for Enhanced Uplink)”, partition 2 is defined in the IE “PRACH preamble control parameters extension list Type 2 (for Enhanced Uplink)”, and partition 3 is defined in “PRACH preamble control parameters extension list Type 3 (for Enhanced Uplink)”

A WCD which supports concurrent deployment of 2 and 10 ms TTI may use, if configured, the following partitions: Rel99 access, Rel8 common E-DCH 10 ms, and partition 1. In addition, if WCD capabilities are such that the WCD can use partition 3, and partition 3 is configured, the WCD may use partition 3. If partition 3 is not configured, the WCD may use partition 2. If WCD capabilities are such that the WCD may use partition 2, and partition 2 is configured, the WCD may use partition 2. If partition 2 is not configured, the WCD should not use partition 3.

As mentioned above, an index value is assigned to each signature in the ordered set of signatures. Specifically, the first signature for R99 access is assigned an index value of 0 and, for each other signature for R99, an index value is assigned to that signature that is one greater than the index value assigned to the immediately preceding signature. Similarly, the first signature for Enhanced Uplink in CELL-FACH is assigned an index value of 0 and, for each other signature for Enhanced Uplink in CELL-FACH, an index value is assigned to that signature that is one greater than the index value assigned to the immediately preceding signature. This is illustrated in FIG. 2.

As illustrated in FIG. 2, signatures 1-3 are used to request access using Release 99 Physical Random Access Channel (PRACH) access; signatures 4-6 are used to request a common E-DCH (these signatures are used by Release 8 WCDs and may be used by Release 11 WCDs, depending on the configuration); signatures 7-9 are used to request a common E-DCH resource, 10 ms TTI (this is used by Release 11 WCDs); signatures 10-15 are used to request a common E-DCH resource, 2 ms TTI (this is used by Release 11 WCDs). For example, if the WCD request 2 ms TTI and selects signature 10 (i.e. signature index (SigInd) 6), the default common E-DCH resource index associated to that signature will be defined by: X=SigInd mod Y. If Y=32, then X=6 mod 32=6, since in this example SigInd=6. The WCD would then consider that the default common E-DCH resource to be used is number 6. This is problematic, however, because in Release 11, common E-DCH resource index 6 may not be a common E-DCH 2 ms TTI resource. Thus, there may be erroneous mappings between the signature index values assigned to signatures to request common E-DCH 2 ms TTI resources and the corresponding common E-DCH resources.

Recognizing this problem, the inventors have conceived of an elegant solution to correct these erroneous mappings. The solution makes use of the fact that the first partition 2 or partition 3 2 ms TTI common E-DCH resource index value is defined by the IE “Concurrent TTI partition index” (CTPI) which is configured and broadcast by the network. To ensure that the WCD does not calculate the wrong default E-DCH resource index, a new formula for calculating the default E-DCH resource index is proposed. This new formula is:

X=(SigInd−SigInd₀+CTPI)mod Y,

where CTPI is the first partition 2 or partition 3 2 ms TTI common E-DCH resource index (i.e., CTPI is the value contained in the “Concurrent TTI partition index” IE) and SigInd₀ is the index value assigned to the first signature in the partition 2 or partition 3 (“partition2/3”) set of signatures, which are used to request a E-DCH 2 ms TTI (using the example shown in FIG. 2, SigInd₀ is 6). Such an E-DCH 2 ms TTI is referred to herein as a partition2/3 E-DCH 2 ms TTI.

In an alternative embodiment, the following formula may be used:

X=(SigInd+CTPI)mod Y.

In this alternative embodiment, the index value assigned to the first signature in the parition2/partition3 signature set, which set of signatures is used to request a E-DCH 2 ms TTI, is set to 0 (i.e., SigInd₀=0), and, for each subsequent signature included in the set, the index value for the signature is set to a value that is one greater than the index value assigned to the signature that immediately precedes the signature. Using the example shown in FIG. 2, signature 10 would be assigned an index value of 0, signature 11 would be assigned an index value of 1, , and signature 15 would be assigned an index value of 5.

Another way to write each of the above formulas is:

X=(n+CTPI−1)mod Y,

where n is the position of the selected signature within the set (e.g., n is the selected signature's signature number).

In one embodiment, the following formula may be used: X=(SigInd mod (Y−CTPI))+CTPI. This formula is useful when there are more signatures configured than broadcasted common E-DCH resources. To avoid the wrap around problem and end up in a different TTI than requested the above formula could be used.

Accordingly, in one aspect there is provided a method for determining a default Enhanced Dedicated Channel, E-DCH, resource index. In some embodiments, the method includes storing a Concurrent Transmission Time Interval, TTI, Partition Index, CTPI, and storing an ordered set of signatures, wherein each signature included in the ordered set is mapped to a default common E-DCH 2 ms TTI resource. The method also includes assigning a signature index value of zero to the first signature included in said ordered set; and for each other signature included in said set, assigning a signature index value to the signature wherein the assigned signature index value is one greater than the signature index value assigned to the immediately preceding signature in said set. The method also includes, for a given signature included in the ordered set, determining the signature index value, SigInd, assigned to the given signature; and for the given signature, determining the default E-DCH resource index mapped to the given signature by calculating one of: a) (SigInd+CTPI) mod Y and b) (SigInd mod (Y−CTPI))+CTPI, where Y is the total number of E-DCH resources configured in the cell for Enhanced Uplink in CELL_FACH state and IDLE mode.

In another aspect there is a method for calculating a default Enhanced Dedicated Channel, E-DCH, resource index. In some embodiments, the method includes receiving a Concurrent Transmission Time Interval, TTI, Partition Index, CTPI. The method also includes calculating (SigInd+CTPI) mod Y or calculating (SigInd mod (Y−CTPI))+CTPI. Y is the total number of E-DCH resources configured in a cell for Enhanced Uplink in CELL_FACH state and IDLE mode, and SigInd is the signature index value of the Nth PRACH preamble signature corresponding to an access indicator, AI, that is configured available in the cell and corresponding to E-DCH transmission for Enhanced Uplink in CELL_FACH state and IDLE mode.

In another aspect, the disclosure provides an apparatus for determining a default Enhanced Dedicated Channel, E-DCH, resource index. In some embodiments, the apparatus is adapted to store a Concurrent Transmission Time Interval, TTI, Partition Index, CTPI and also store an ordered set of signatures, wherein each signature included in the ordered set is mapped to a default common E-DCH 2 ms TTI resource. The apparatus is also adapted to assign a signature index value of zero to the first signature included in said ordered set; and for each other signature included in said set, assign a signature index value to the signature wherein the assigned signature index value is one greater than the signature index value assigned to the immediately preceding signature in said set. The apparatus is also adapted to, for a given signature included in the ordered set, determine the signature index value, SigInd, assigned to the given signature; and for the given signature, determine the default E-DCH resource index mapped to the given signature by calculating one of: a) (SigInd+CTPI) mod Y and b) (SigInd mod (Y−CTPI))+CTPI, where Y is the total number of E-DCH resources configured in the cell for Enhanced Uplink in CELL_FACH state and IDLE mode.

In another aspect, the disclosure provides an apparatus for calculating a default Enhanced Dedicated Channel, E-DCH, resource index, the apparatus is adapted to receive a Concurrent Transmission Time Interval, TTI, Partition Index, CTPI. The apparatus is further adapted to calculate (SigInd+CTPI) mod Y or calculate (SigInd mod (Y−CTPI))+CTPI, where Y is the total number of E-DCH resources configured in a cell for Enhanced Uplink in CELL_FACH state and IDLE mode, and SigInd is the signature index value of the Nth PRACH preamble signature corresponding to an access indicator, AI, that is configured available in the cell and corresponding to E-DCH transmission for Enhanced Uplink in CELL_FACH state and IDLE mode.

In another aspect an apparatus is provided, the apparatus includes a data processing system and a data storage system. The data storage system contains instructions executable by the data processing system wherein the apparatus is operative to store a Concurrent Transmission Time Interval, TTI, Partition Index, CTPI; and store an ordered set of signatures, wherein each signature included in the ordered set is mapped to a default common Enhanced Dedicated Channel, E-DCH, 2 ms TTI resource. The apparatus is further operative to assign a signature index value of zero to the first signature included in said ordered set; and for each other signature included in said set, assign a signature index value to the signature wherein the assigned signature index value is one greater than the signature index value assigned to the immediately preceding signature in said set. The apparatus is further operative to, for a given signature included in the ordered set, determine the signature index value, SigInd, assigned to the given signature; and for the given signature, determine the default E-DCH resource index mapped to the given signature by calculating one of: a) (SigInd+CTPI) mod Y and b) (SigInd mod (Y−CTPI))+CTPI, where Y is the total number of E-DCH resources configured in the cell for Enhanced Uplink in CELL_FACH state and IDLE mode.

In another aspect, there is provided a wireless communication device, WCD, capable of calculating a default E-DCH resource index. In some embodiments, the WCD includes a processor and a memory unit. The memory unit stores instructions. The instructions are executable by the processor wherein the WCD is operative to store a received Concurrent Transmission Time Interval, TTI, partition Index (CTPI). The WCD is further operative to calculate ((SigInd+CTPI) mod Y) or ((SigInd mod (Y−CTPI))+CTPI), where Y is the total number of E-DCH resources configured in a cell for Enhanced Uplink in CELL_FACH state and IDLE mode, and SigInd is the signature index value of the Nth PRACH preamble signature corresponding to an access indicator, AI, that is configured available in the cell and corresponding to E-DCH transmission for Enhanced Uplink in CELL_FACH state and IDLE mode.

The above and other aspects and embodiments are described in further detail below.

### BRIEF DESCRIPTION OF THE DRAWINGS

FIG. 1 illustrates an example communication network.

FIGS. 2-9 illustrates various way in which index values may be assigned to signatures.

FIG. 10 is a flow chart illustrating a process according to some embodiments.

FIG. 11 is a flow chart illustrating a process according to some embodiments.

FIG. 12 is a flow chart illustrating a process according to some embodiments.

FIG. 13 is a flow chart illustrating a process according to some embodiments.

FIG. 14 is a flow chart illustrating a process according to some embodiments.

FIG. 15 is a block diagram of a WCD according to some embodiments.

FIG. 16 is a block diagram of an apparatus according to some embodiments.

FIG. 17 is a flow chart illustrating a process according to some embodiments.

FIG. 18 is a flow chart illustrating a process according to some embodiments.

### DETAILED DESCRIPTION

As discussed above, erroneous mappings between signatures and default common E-DCH resources may occur when concurrent 2 and 10 ms TTI is used in Release 11. The erroneous mapping is due to the way in which index values are assigned to signatures and the mapping formula that is used to map an index value assigned to a signature to a common E-DCH resource.

This disclosure provides a mechanism to correctly map signatures to common E-DCH resources in the environment where WCDs and the network support concurrent deployment of 2 and 10 ms TTI and at least one of the partitions (partition 1, partition 2 or partition 3) is configured.

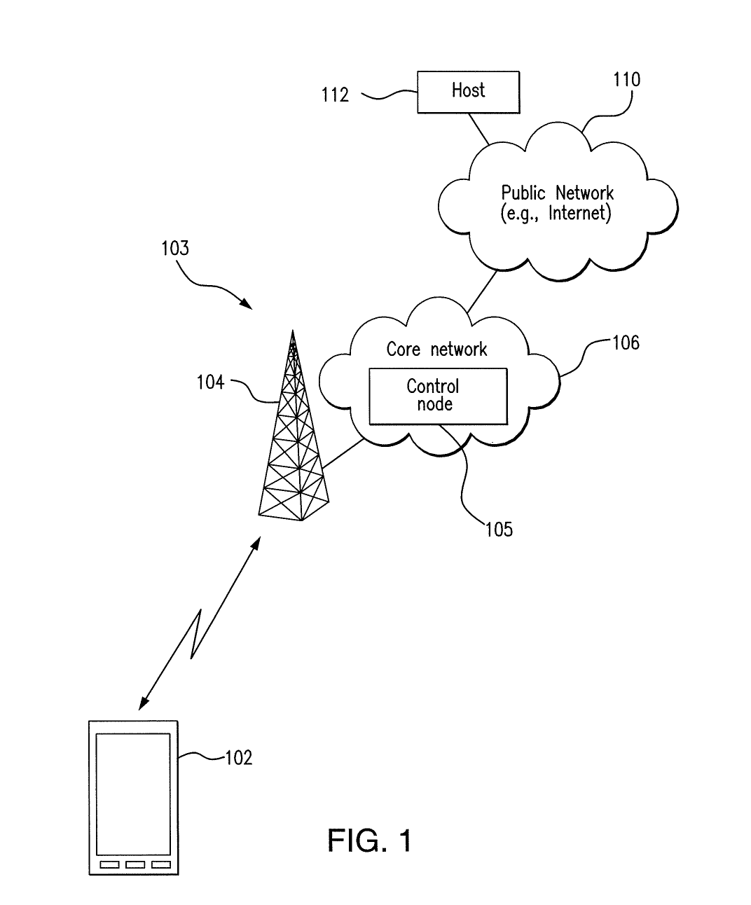

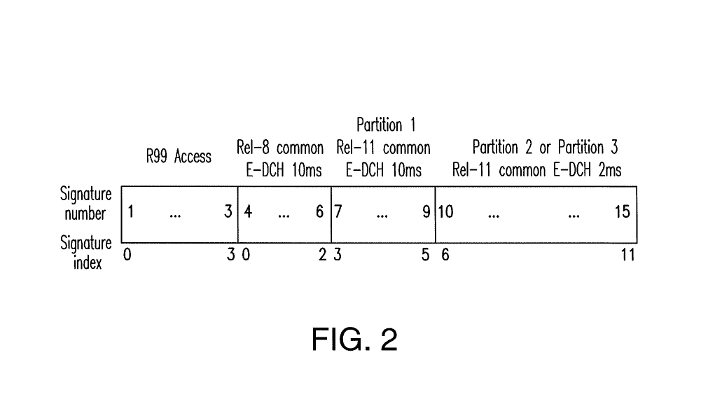

Referring now to FIG. 1, FIG. 1 illustrates a WCD 102 in communication with a communication network 103, that includes a network node 104 (e.g., a base station) and a core network 106, which may be connected to a public network 110 (e.g. the Internet). In some embodiments, the communication network 103 enables WCD 102 to communicate with hosts (e.g., host 112) connected to public network 110 via communication network 103.

As mentioned above, the communication network 103 may configure common E-DCH resources with 10 ms TTI and common E-DCH resources with 2 ms TTI. This is called concurrent deployment of 10 and 2 ms TTI. To configure concurrent deployment of 2 and 10 ms TTI, the communication network 103 needs to broadcast the information elements (IEs) which contain the relevant information to configure the feature in the WCD 102.

One Preamble Scrambling Code is Configured

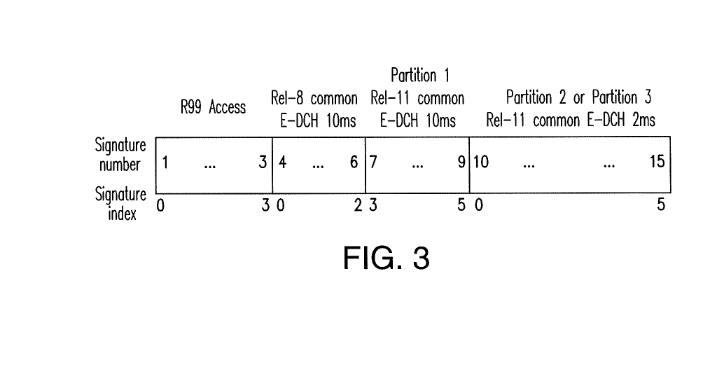

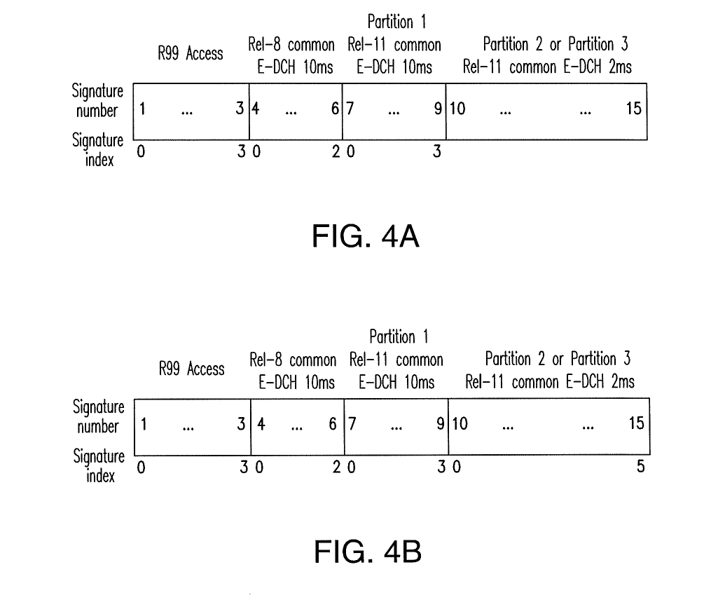

In one particular embodiment where only one scrambling code is configured (i.e., all signature subsets are defined under the same scrambling code number), to avoid erroneous mappings between partition2/3 signatures and the 2 ms E-DCH resources when concurrent deployment of 10 and 2 ms TTI is configured, the WCD 102 and an entity of network 103 (e.g., base station 102 or a control node 105 within core network 106) assigns signature indexes to the signatures used for requesting a partition2/3 2 ms TTI (i.e., the signatures in the partition2/3 set of signatures) so that the first available signature allocated to request a partition2/3 2 ms TTI for a Release 11 WCD is assigned a signature index value of 0, and continuing in sequence, in the order of increasing signature numbers. An example is shown in FIG. 3 and FIG. 4B.

As illustrated in the example shown in FIG. 3 and FIG. 4B, signatures 10, 11, 12, 13, 14, and 15, which are the signatures in the partition2/3 signature set, are used by the WCD when the WCD determines to request a partition2/3 2 ms TTI resource. As also illustrated in FIGS. 3 and 4B, a signature index value of 0 is assigned to signature number 10, a signature index value of 1 is assigned to signature number 11, a signature index value of 2 is assigned to signature number 12, a signature index value of 3 is assigned to signature number 13, a signature index value of 4 is assigned to signature number 14, and a signature index value of 5 is assigned to signature number 15.

In addition, to assigning the index values as described immediately above, the WCD 102 and an entity of network 103 determines the default E-DCH resource index corresponding to a signature selected by the WCD to request a partition2/3 2 ms TTI resource (i.e., a signature selected from the partition2/3 set of signatures) by calculating a value X using an equation of the form:

X=(SigInd+CTPI)mod Y,

where X is the default E-DCH resource index that identifies the common E-DCH resource mapped to the selected signature, Y is the total number of E-DCH resources configured in the cell for Enhanced Uplink in CELL_FACH state and IDLE mode, SigInd is an integer (a.k.a., index value) associated with the selected signature, and CTPI is the first partition2/3 2 ms TTI common E-DCH resource index value (i.e., CTPI is the value contained in the “Concurrent TTI partition index” IE).

In another embodiment X is calculated using the formula:

X=(SigInd mod(Y−CTPI))+CTPI.

In another embodiment, rather than assign a signature index value of 0 to the first available signature in the partition2/3 signature set, the WCD 102 and the network 103 may assign to the first available signature an index value of SigInd₀, where SigInd₀ is any arbitrary integer greater than zero. In this embodiment, the WCD 102 and an entity of network 103 determines the default E-DCH resource index corresponding to a signature selected by the WCD from the partition2/3 signature set by calculating a value X using an equation of the form:

X=(SigInd−SigInd₀+CTPI)mod Y.

The signatures in Partition 1 could also be renumbered in two different ways.

First, the first available signature allocated in partition 1 is signature index 0, and continuing in sequence, in the order of increasing signature numbers. This is illustrated in FIG. 4A and FIG. 4B.

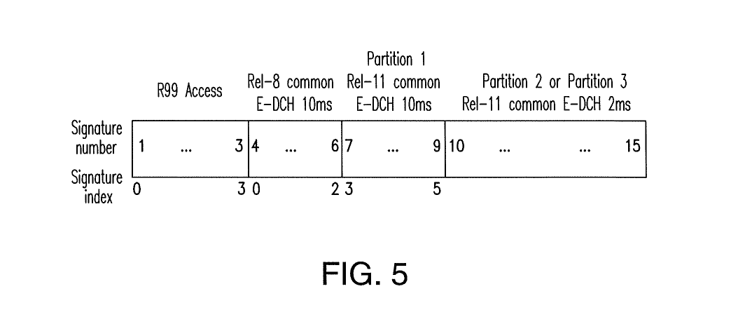

Second, the first available signature number allocated in partition 1 continues the sequence in the order of increasing signature numbers started in Release 8 for those signatures allocated to request a 10 ms TTI common E-DCH resource. This is illustrated in FIG. 5.

Multiple Preamble Scrambling Codes are Configured

A. Partition 2/Partition 3 Signature Sets:

Each preamble scrambling code is associated with a set of signatures, which are subdivided into sub-sets, including Release 11 partition 2 or partition 3 signature sets. When multiple (i.e., more than one) PRACH preamble scrambling codes are configured for partition 2 and/or partition 3, the signature index values can be assigned in two different ways.

First Option:

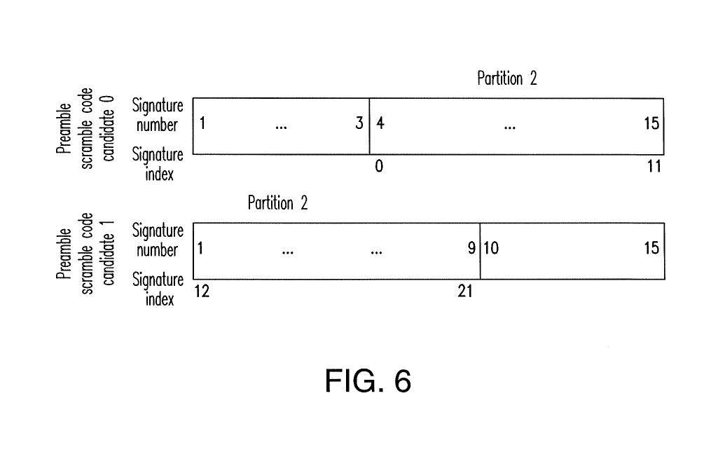

For the first candidate PRACH preamble scrambling code, the first available signature allocated in partition Z (where Z is 2 or 3) is assigned a signature index value of 0, and continuing in sequence, in the order of increasing signature numbers across the list of candidate PRACHs preamble control parameters defined in the IE “PRACH preamble control parameters list” and compiled by the WCD. An example of this first option is shown in FIG. 6.

As shown in FIG. 6, the fourth signature in the signature set associated with preamble scrambling code candidate 0 is the first available signature in the set of signatures assigned to Partition 2. Thus, a signature index value of 0 is assigned to signature number 4, and, for each signature following this signature within the set of signatures associated with candidate 0 and assigned to Partition 2, a signature index value is assigned to the signature such that the assigned signature is one greater than the signature index value assigned to the immediately preceding signature. Additionally, as shown in the example, the first available signature in the set of signatures associated with candidate 1 and assigned to Partition 2 is assigned an index value of 12 because the last available signature in the in the set of signatures associated with candidate 0 and assigned to Partition 2 is assigned an index value of 11.

Second Option:

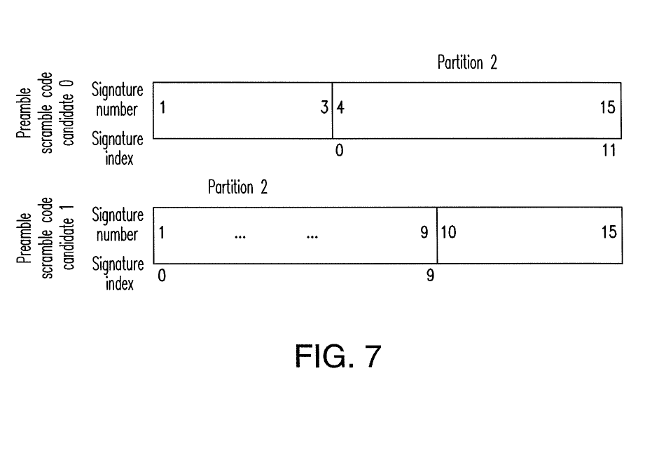

The first available signature number allocated in partition Z (where Z is 2 or 3) is signature index 0, and continuing in sequence, in the order of increasing signature numbers. This is done per each candidate PRACHs preamble control parameters defined in the IE “PRACH preamble control parameters list”. An example of this second option is shown in FIG. 7.

As shown in FIG. 7, the fourth signature in the signature set associated with preamble scrambling code candidate 0 is the first available signature in the set of signatures assigned to Partition 2. Thus, a signature index value of 0 is assigned to signature number 4, and, for each signature following this signature within the set of signatures associated with candidate 0 and assigned to Partition 2, a signature index value is assigned to the signature such that the assigned signature is one greater than the signature index value assigned to the immediately preceding signature. Additionally, as shown in the example, the first available signature in the set of signatures associated with candidate 1 and assigned to Partition 2 is also assigned an index value of 0, and for each signature following this signature within the set of signatures associated with candidate 1 and assigned to Partition 2, a signature index value is assigned to the signature such that the assigned signature is one greater than the signature index value assigned to the immediately preceding signature.

B. Other Signature Sets

When multiple PRACH preamble control parameters are configured for partition 1, for those PRACH defined in “PRACH preamble control parameters extension list Type 1 (for Enhanced Uplink)” and which preamble scrambling code number is different than the one defined in “Common E-DCH system info” in System Information Block (SIB) 5/5bis, the renumbering could be done in two different ways.

First Option:

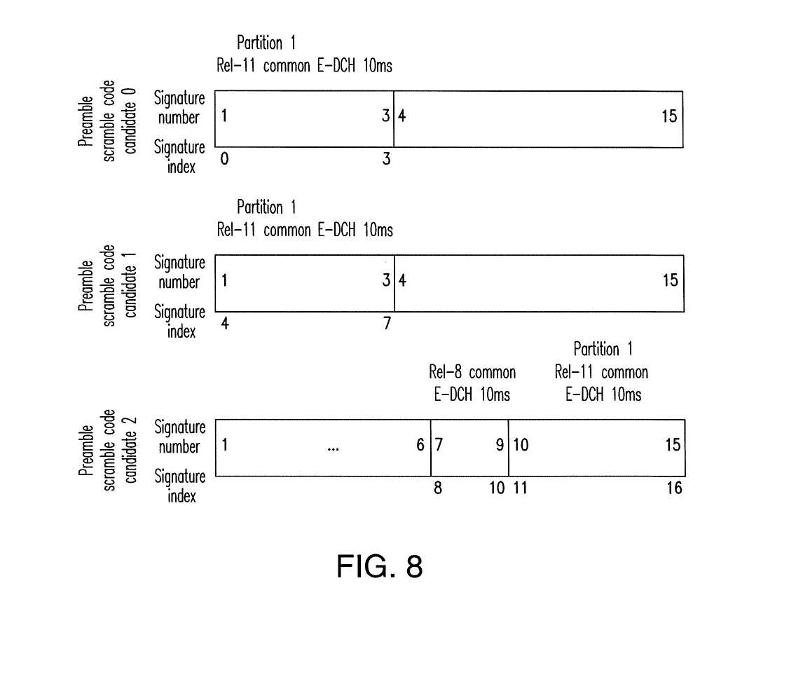

For the first candidate PRACH preamble control parameter, the first available signature number allocated in partition Z (where Z is 1) is signature index 0, and continuing in sequence, in the order of increasing signature numbers across the list of candidate PRACHs preamble control parameters defined in the IE “PRACH preamble control parameters list” and compiled by the WCD. This case is exactly the same as for case 1) outlined above for Partition 2 and Partition 3. An example of this first option is shown in FIG. 8.

Second Option:

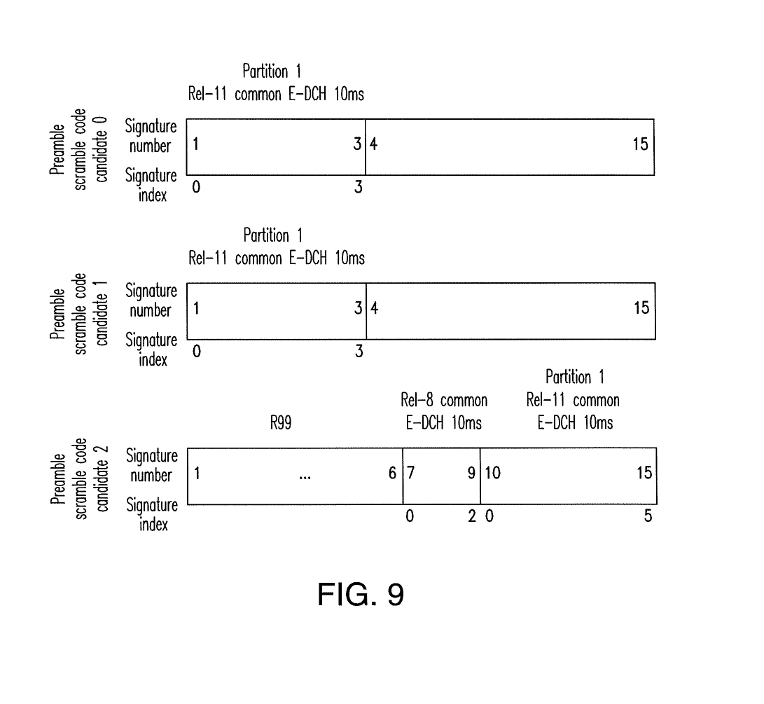

The first available signature number allocated in partition Z (where Z is 1) is signature index 0, and continuing in sequence, in the order of increasing signature numbers. This is done per each candidate PRACHs preamble control parameters defined in the IE “PRACH preamble control parameters list” and compiled by the WCD. This option is exactly the same as for option 2 outlined above for Partition 2 and Partition 3 An example of this second option is shown in FIG. 9.

Advantages

The advantages provided by this disclosure include the advantage of ensuring that signatures can be associated correctly to the default common E-DCH resource indexes. This avoids the network 103 and the WCD 102 calculating different common E-DCH resources. In such case, loss of data may happen.

Exemplary Methods

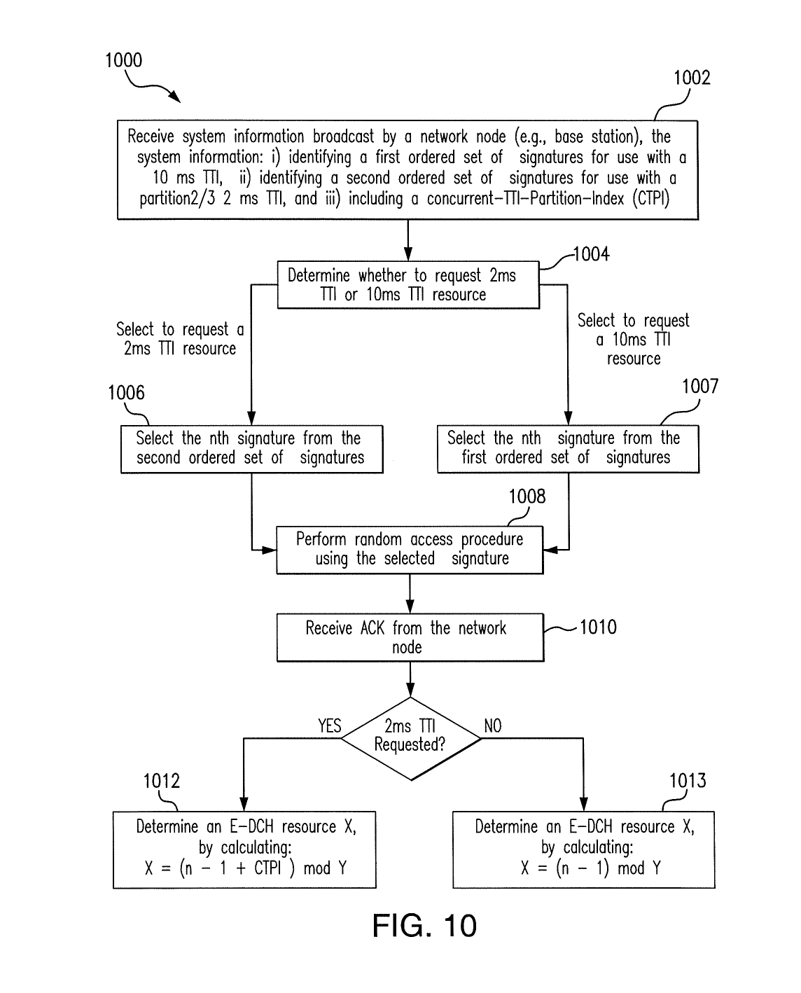

FIG. 10 is a flow chart illustrating a process 1000 performed by WCD 102 in one embodiment. Process 1000 may begin in step 1002 where WCD 102 receives system information (e.g., a SIB) broadcast by network node (e.g., base station) 104 using, for example, a broadcast channel (BCH), the system information: i) identifying a first ordered set of signatures for use with a 10 ms TTI, ii) identifying a second ordered set of signatures (e.g., the partition2/3 signature set), and iii) including a concurrent-TTI-Partition-Index (CTPI).

In step 1004, WCD 102 determines the type of resource to request (e.g., it determines whether it should request a partition2/3 2 ms TTI resource). If WCD 102 selects a partition2/3 2 ms TTI resource, then the process proceeds to step 1006. If WCD 102 selects a 10 ms TTI resource, then the process proceeds to step 1007.

In some embodiments, WCD determines the type of resource to request (e.g., whether it should select to request a 2 ms or a 10 ms E-DCH resource) based on a power headroom value calculated by WCD 102 and a threshold power value. For example, if the power headroom value exceeds the threshold, then, as a result, WCD 102 selects the 2 ms TTI.

In step 1006, WCD 102 selects the n'th signature from the second ordered set of signatures. In step 1007, WCD 102 selects the n'th signature from the first ordered set of signatures.

In step 1008, WCD 102 performs the random access procedure using the selected signature.

In step 1010, WCD 102 receives an ACK from the network node 104.

Depending on whether the 2 ms TTI or the 10 ms TTI was selected, the process proceeds to either step 1012 or step 1013.

In step 1012, WCD 102 determines the default E-DCH resource index X, by calculating: X=(n−1+CTPI) mod Y, where Y is defined above and n is a value identifying the position of the selected signature within the second ordered set of signatures. For example, if WCD selected the first signature from the set in step 1006, the n will equal 1. Similarly, if WCD selected the third signature from the set in step 1006, then n will equal 3.

In step 1013, WCD 102 determines the default E-DCH resource index X, by calculating: X=(n−1) mod Y, where Y is defined above and n is a value identifying the position of the selected signature within the first ordered set of signatures.

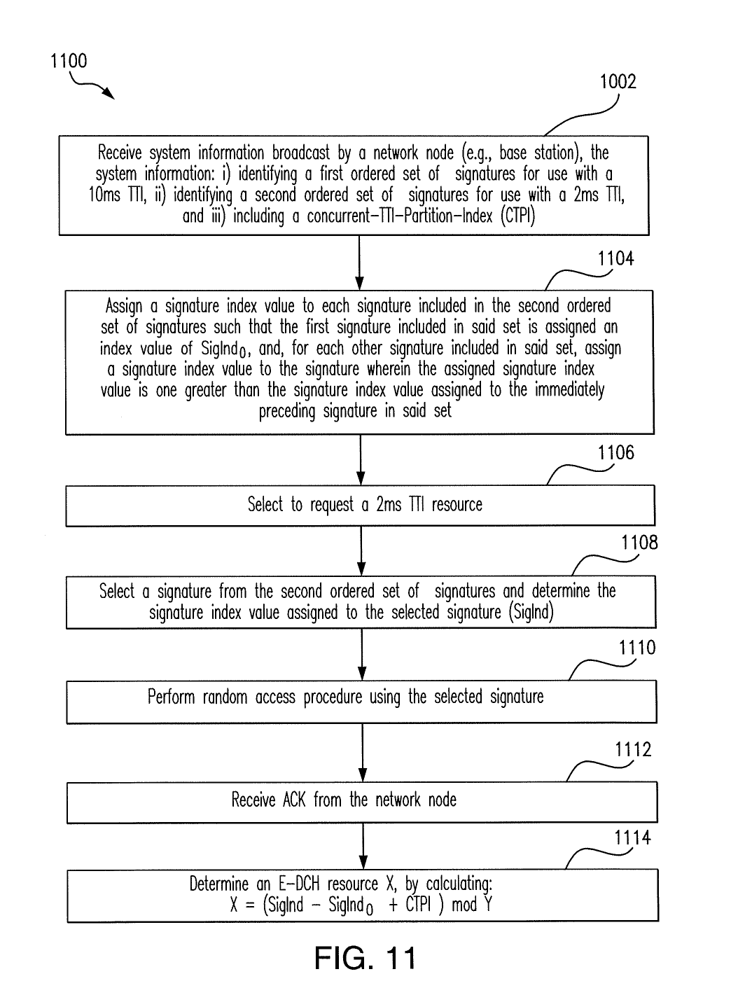

FIG. 11 is a flow chart illustrating a process 1100 performed by WCD 102 according to another embodiment. Process 1100 may begin with step 1002 (described above).

In step 1104, WCD 102 assigns a signature index value to each signature included in the second ordered set of signatures such that the first signature included in said set is assigned an index value of SigInd₀, and, for each other signature included in said set, assign a signature index value to the signature wherein the assigned signature index value is one greater than the signature index value assigned to the immediately preceding signature in said set

In step 1106, WCD 102 selects to request a 2 ms TTI resource. The requested 2 ms TTI resource may be a partition2/3 (i.e. a partition 2 or partition 3) 2 ms III resource.

In step 1108, WCD 102 selects a signature from the second ordered set of signatures and determines the signature index value assigned to the selected signature (SigInd).

In step 1110, WCD 102, performs random access procedure using the selected signature.

In step 1112, WCD 102 receives an ACK from the network node 104.

In step 1114, WCD 102 determines the default E-DCH resource index X, by calculating: X=(SigInd−SigInd₀+CTPI) mod Y

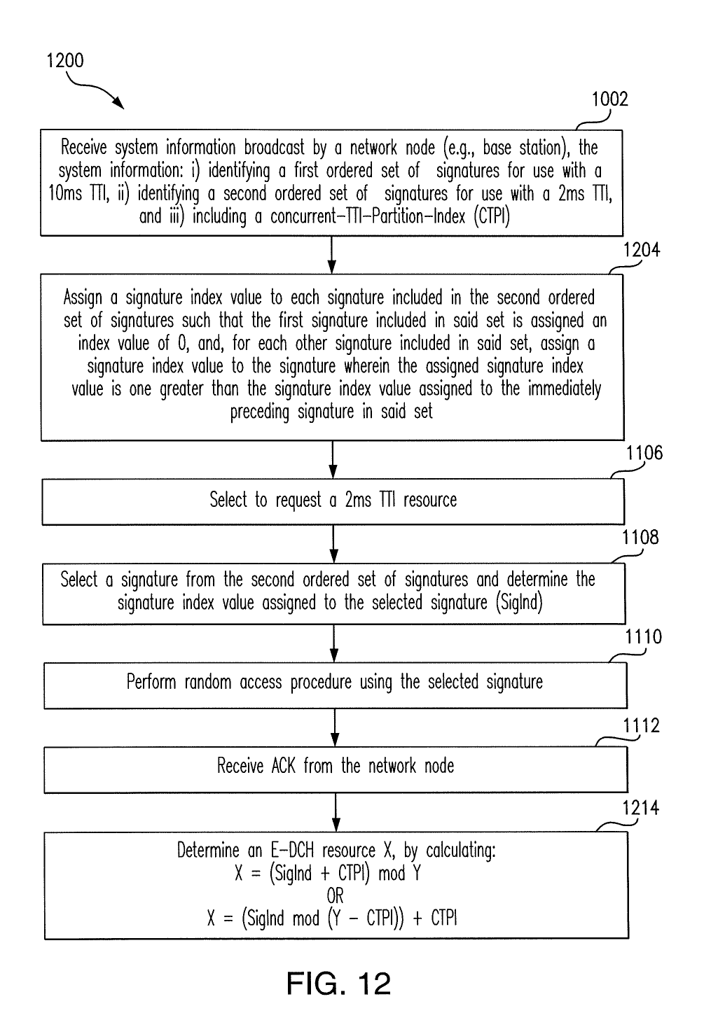

FIG. 12 is a flow chart illustrating a process 1200 performed by WCD 102 according to another embodiment. Process 1200 is identical to process 1100 with the exceptions that step 1204 replaces step 1104 and step 1214 replaces step 1114. In step 1214, WCD 102 assigns a signature index value to each signature included in the second ordered set of signatures such that the first signature included in said set is assigned an index value of 0, and, for each other signature included in said set, assign a signature index value to the signature wherein the assigned signature index value is one greater than the signature index value assigned to the immediately preceding signature in said set.

In step 1214, WCD 102 determines the default E-DCH resource index X, by calculating X=(SigInd+CTPI) mod Y, or by calculating X=(SigInd mod (Y−CTPI))+CTPI.

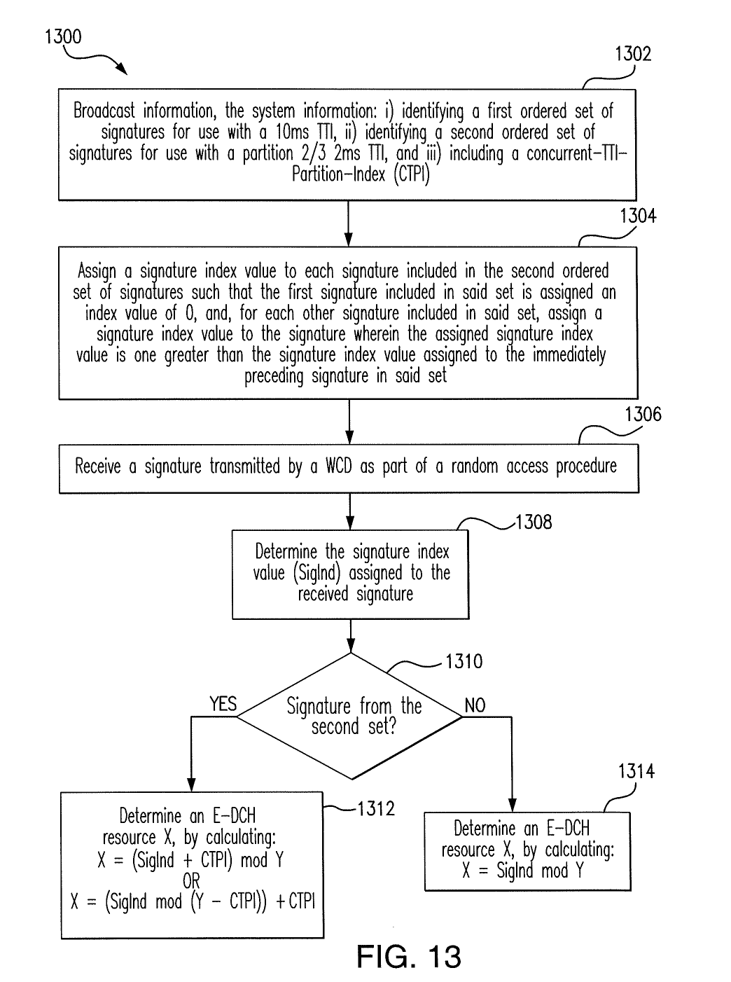

FIG. 13 is a flow chart illustrating a process 1300 performed by network 103 (i.e., by one or more entities of network 103, such as base station 104 and/or control node 105) according to one embodiment.

Process 1300 begins in step 1302, where network 103 broadcasts system information (e.g., one or more SIBs) using, for example, a broadcast channel (BCH), where the system information: i) identifies a first ordered set of signatures for use with a 10 ms TIT, ii) identifies a second ordered set of signatures for use with a partition2/3 2 ms TTI, and iii) includes a concurrent-TTI-Partition-Index (CTPI).

In step 1304, network 103 assigns a signature index value to each signature included in the second ordered set of signatures such that the first signature included in said set is assigned an index value of 0, and, for each other signature included in said set, assign a signature index value to the signature wherein the assigned signature index value is one greater than the signature index value assigned to the immediately preceding signature in said set.

In step 1306, network 103 receives a signature transmitted by WCD 102 as part of a random access procedure.

In step 1308, network 103 determines the signature index value (SigInd) assigned to the received signature.

In step 1310, network 103 determines whether the signature is from the second ordered set of signature. If the received signature is determined to be from the second ordered set of signatures, then process 1300 proceeds to step 1312, otherwise process 1300 proceeds to step 1314.

In step 1312, network 103 determines a default common E-DCH resource index X, by calculating: X=(SigInd+CTPI) mod Y, or by calculating X=(SigInd mod (Y−CTPI))+CTPI.

In step 1314, network 103 determines the default E-DCH resource index X, by calculating: X=SigInd mod Y.

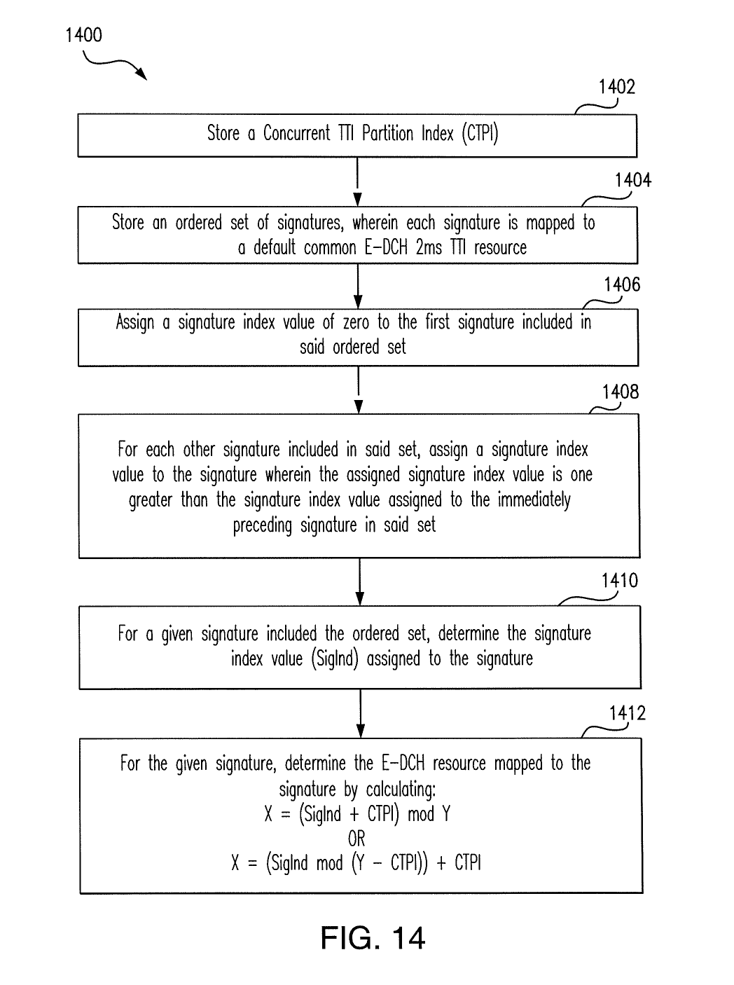

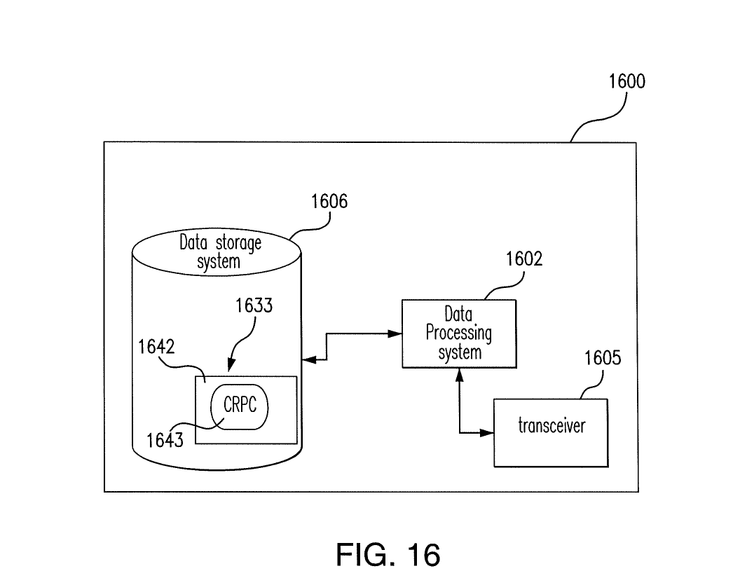

FIG. 14 is flow chart illustrating a process 1400 performed by an apparatus 1600 (see FIG. 16) according to one embodiment. The apparatus 1600 may be WCD 102 or it may be a network apparatus of network 103 (e.g., a base station or control node).

Process 1400 begins in step 1402 where apparatus 1600 stores a concurrent-TTI-Partition-Index (CTPI).

In step 1404, apparatus 1600 stores an ordered set of partition2/3 signatures, wherein each signature included in the ordered set is mapped to a default common E-DCH 2 ms TTI resource (partition2/3).

In step 1406, apparatus 1600 assigns a signature index value of zero to the first signature included in said ordered set (i.e., lowest available signature number).

In step 1408, for each other signature included in said set, apparatus 1600 assigns a signature index value to the signature wherein the assigned signature index value is one greater than the signature index value assigned to the immediately preceding signature in said set.

In step 1410, for a given signature included in the ordered set, apparatus 1600 determines the signature index value (SigInd) assigned to the given signature.

In step 1412, for the given signature, apparatus 1600 determines the default E-DCH resource index mapped to the given signature by calculating X=(SigInd+CTPI) mod Y, or by calculating X=(SigInd mod (Y−CTPI))+CTPI.

Exemplary WCD

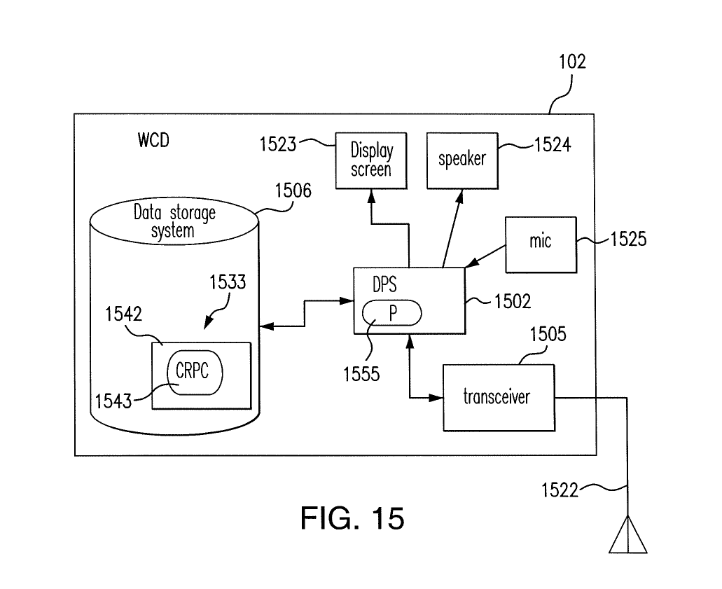

FIG. 15 illustrates a block diagram of an example WCD 102. As shown in FIG. 15, WCD 102 includes: a data processing system (DPS) 1502, which may include one or more processors (P) 1555 (e.g., microprocessors) and/or one or more circuits, such as an application specific integrated circuit (ASIC), Field-programmable gate arrays (FPGAs), etc.; a transceiver 1505, connected to an antenna 1522, for receiving messages from, and transmitting messages to, network 103; a data storage system 1506, which may include one or more computer-readable data storage mediums, such as non-transitory memory unit (e.g., hard drive, flash memory, optical disk, etc.) and/or volatile storage apparatuses (e.g., dynamic random access memory (DRAM)).

In embodiments where data processing system 1502 includes a processor 1555 (e.g., a microprocessor), a computer program product 1533 may be provided, which computer program product includes: computer readable program code 1543 (e.g., instructions), which implements a computer program, stored on a computer readable medium 1542 of data storage system 1506, such as, but not limited, to magnetic media (e.g., a hard disk), optical media (e.g., a DVD), memory devices (e.g., random access memory), etc. In some embodiments, computer readable program code 1543 is configured such that, when executed by data processing system 1502, code 1543 causes the data processing system 1502 to perform steps described herein (e.g., steps shown in FIGS. 10, 11, 12, 14, 17, and 18).

In some embodiments, WCD 102 is configured to perform steps described above without the need for code 1543. For example, data processing system 1502 may consist merely of specialized hardware, such as one or more application-specific integrated circuits (ASICs). Hence, the features of the present invention described above may be implemented in hardware and/or software. For example, in some embodiments, the functional components of WCD 102 described above may be implemented by data processing system 1502 executing program code 1543, by data processing system 1502 operating independent of any computer program code 1543, or by any suitable combination of hardware and/or software.

In a second embodiment, WCD 102 further includes: 1) a display screen 1523 coupled to the data processing system 1502 that enables the data processing system 1502 to display information to a user of WCD 102; 2) a speaker 1524 coupled to the data processing system 1502 that enables the data processing system 1502 to output audio to the user of WCD 102; and 3) a microphone 1525 coupled to the data processing system 1502 that enables the data processing system 1502 to receive audio from the user.

Exemplary Apparatus

FIG. 16 illustrates a block diagram of an apparatus 1600 according to some embodiments. As shown in FIG. 16, apparatus 1600 may include: a data processing system 1602, which may include one or more processors (e.g., microprocessors) and/or one or more circuits, such as an application specific integrated circuit (ASIC), Field-programmable gate arrays (FPGAs), etc.; a transceiver 1605 for receiving message from, and transmitting messages to, another apparatus; a data storage system 1606, which may include one or more computer-readable data storage mediums, such as non-transitory data storage apparatuses (e.g., hard drive, flash memory, optical disk, etc.) and/or volatile storage apparatuses (e.g., dynamic random access memory (DRAM)). In embodiments where data processing system 1602 includes a processor (e.g., a microprocessor), a computer program product 1633 may be provided, which computer program product includes: computer readable program code 1643 (e.g., instructions), which implements a computer program, stored on a computer readable medium 1642 of data storage system 1606, such as, but not limited, to magnetic media (e.g., a hard disk), optical media (e.g., a DVD), memory devices (e.g., random access memory), etc. In some embodiments, computer readable program code 1643 is configured such that, when executed by data processing system 1602, code 1643 causes the data processing system 1602 to perform steps described herein (e.g., steps shown in FIG. 13 or 14). In some embodiments, apparatus 1600 may be configured to perform steps described above without the need for code 1643. For example, data processing system 1602 may consist merely of specialized hardware, such as one or more application-specific integrated circuits (ASICs). Hence, the features of the present invention described above may be implemented in hardware and/or software.

UMTS Specification Update

Based on the disclosure above, we propose an update to the Universal Mobile Telecommunications System (UMTS) Radio Resource Control (RRC) Protocol specification as follows:

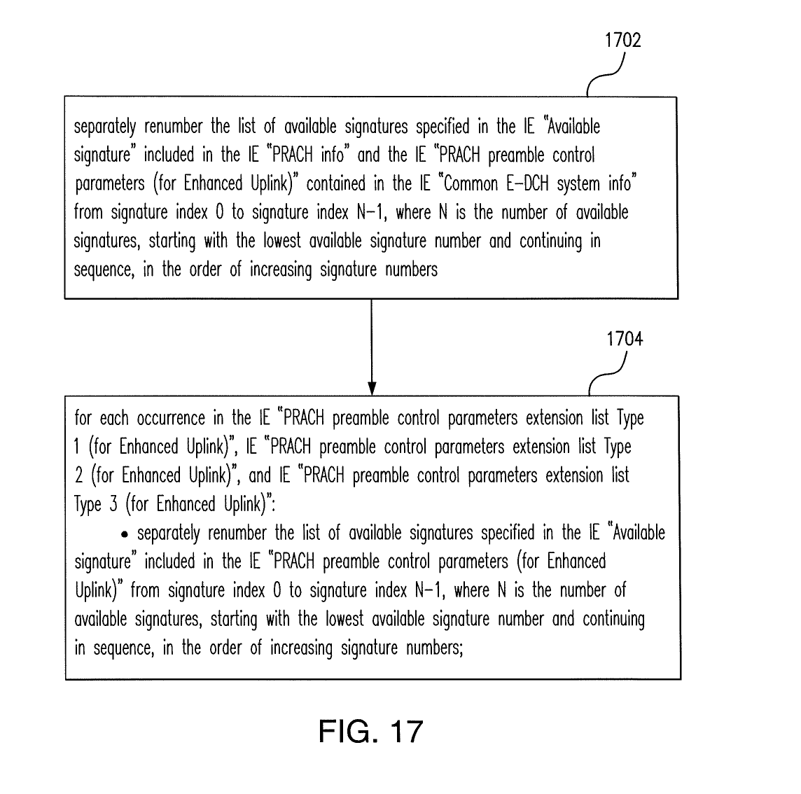

If the IE “ASC setting” is included, the WCD 102 (referred to as UE in the specification) shall establish the available signatures for this ASC as specified in the following:
separately renumber the list of available signatures specified in the IE “Available signature” included in the IE “PRACH info” and the IE “PRACH preamble control parameters (for Enhanced Uplink)” contained in the IE “Common E-DCH system info” from signature index 0 to signature index N−1, where N is the number of available signatures, starting with the lowest available signature number and continuing in sequence, in the order of increasing signature numbers (see FIG. 17, step 1702);
for each occurrence in the IE “PRACH preamble control parameters extension list Type 1 (for Enhanced Uplink)”, IE “PRACH preamble control parameters extension list Type 2 (for Enhanced Uplink)”, and IE “PRACH preamble control parameters extension list Type 3 (for Enhanced Uplink)”
   separately renumber the list of available signatures specified in the IE “Available signature” included in the IE “PRACH preamble control parameters (for Enhanced Uplink)” from signature index 0 to signature index N−1, where N is the number of available signatures, starting with the lowest available signature number and continuing in sequence, in the order of increasing signature numbers (see FIG. 17, step 1704);
consider as available signatures for this ASC the signatures included in this renumbered list from the index specified by the IE “Available signature Start Index” to the index specified by the IE “Available signature End Index”.

The above process is illustrated in FIG. 17.

Concise Description of Various Aspects and Embodiments

In a first aspect, there is provided a method for determining a default E-DCH resource index. The method includes: 1) storing a concurrent TTI Partition index (CTPI); 2) storing an ordered set of signatures, wherein each signature included in the ordered set is mapped to a default common E-DCH 2 ms TTI resource; 3) assigning a signature index value of zero to the first signature included in said ordered set (i.e., to the lowest available signature number); 4) for each other signature included in said set, assigning a signature index value to the signature wherein the assigned signature index value is one greater than the signature index value assigned to the immediately preceding signature in said set; 5) for a given signature included in the ordered set, determining the signature index value (SigInd) assigned to the given signature; and 6) for the given signature, determining the default E-DCH resource index mapped to the given signature by calculating one of: 1) X=(SigInd+CTPI) mod Y and 2) X=(SigInd mod (Y−CTPI))+CTPI, where Y is the total number of E-DCH resources configured in the cell for Enhanced Uplink in CELL_FACH state and IDLE mode. In one embodiment, said ordered set of signatures is a partition2/3 signature set.

In a second aspect, a wireless communication device (WCD) is provided. In one embodiment, the WCD comprises: a processor and a memory unit. The memory contains instructions executable by the processor wherein the WCD is operative to: 1) store a concurrent TTI Partition index (CTPI); 2) store an ordered set of signatures, wherein each signature included in the ordered set is mapped to a default common E-DCH 2 ms TTI resource; 3) assign a signature index value of zero to the first signature included in said ordered set (i.e., to the lowest available signature number); 4) for each other signature included in said set, assign a signature index value to the signature wherein the assigned signature index value is one greater than the signature index value assigned to the immediately preceding signature in said set; 5) for a given signature included in the ordered set, determine the signature index value (SigInd) assigned to the given signature; and 6) for the given signature, determine the default E-DCH resource index mapped to the given signature by calculating one of: 1) X=(SigInd+CTPI) mod Y and 2) X=(SigInd mod (Y−CTPI))+CTPI, where Y is the total number of E-DCH resources configured in the cell for Enhanced Uplink in CELL_FACH state and IDLE mode. In a second embodiment, the WCD further includes an antenna, a transceiver coupled to the antenna and the processor, and a display screen coupled to the processor.

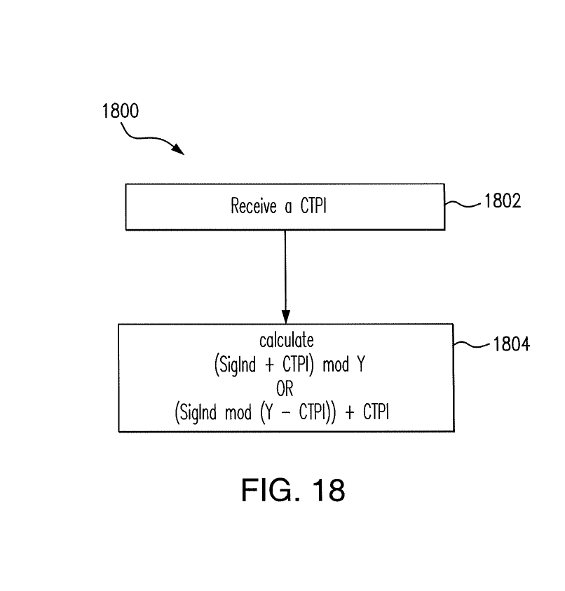

In another aspect, there is provided a method 1800 (see FIG. 18) for calculating a default E-DCH resource index. In one embodiment, the method includes: 1) receiving (see step 1802) a Concurrent TTI partition Index (CTPI); and 2) calculating (see step 1804) (SigInd+CTPI) mod Y or calculating (SigInd mod (Y−CTPI))+CTPI, where Y is the total number of E-DCH resources configured in a cell for Enhanced Uplink in CELL_FACH state and IDLE mode, and SigInd is a signature index value, specifically it is the signature index value of the Nth PRACH (Physical Random Access Channel) preamble signature corresponding to an AI that is configured available in the cell and corresponding to E-DCH transmission for Enhanced Uplink in CELL_FACH state and IDLE mode (e.g., it is the signature index value assigned to the signature selected by the WCD to request 2 ms TTI E-DCH).

In another aspect, there is provided a wireless communication device (WCD) capable of calculating a default E-DCH resource index. In one embodiment, the WCD comprises: a processor and a memory unit. The memory contains instructions executable by the processor wherein the WCD is operative to: 1) store a received Concurrent TTI partition Index (CTPI); and 2) calculate a) ((SigInd+CTPI) mod Y) or b) ((SigInd mod (Y−CTPI))+CTPI), where Y is the total number of E-DCH resources configured in a cell for Enhanced Uplink in CELL_FACH state and IDLE mode, and SigInd is the signature index value of the Nth PRACH preamble signature corresponding to an AI that is configured available in the cell and corresponding to E-DCH transmission for Enhanced Uplink in CELL_FACH state and IDLE mode. In a second embodiment, the WCD further includes an antenna, a transceiver coupled to the antenna and the processor, and a display screen coupled to the processor.

In another aspect, there is provided a wireless communication device (WCD) capable of assigning signature index values to signatures. In one embodiment, the WCD comprises: a processor and a memory unit. The memory contains instructions executable by the processor wherein the WCD is operative to:
separately renumber a list of available signatures specified in the IE “Available signature” included in the IE “PRACH info” and the IE “PRACH preamble control parameters (for Enhanced Uplink)” contained in the IE “Common E-DCH system info” from signature index 0 to signature index N−1, where N is the number of available signatures, starting with the lowest available signature number and continuing in sequence, in the order of increasing signature numbers; and
for each occurrence in the IE “PRACH preamble control parameters extension list Type 1 (for Enhanced Uplink)”, IE “PRACH preamble control parameters extension list Type 2 (for Enhanced Uplink)”, and IE “PRACH preamble control parameters extension list Type 3 (for Enhanced Uplink)”:
   separately renumber the list of available signatures specified in the IE “Available signature” included in the IE “PRACH preamble control parameters (for Enhanced Uplink)” from signature index 0 to signature index N−1, where N is the number of available signatures, starting with the lowest available signature number and continuing in sequence, in the order of increasing signature numbers.

In a second embodiment, the WCD further includes an antenna, a transceiver coupled to the antenna and the processor, and a display screen coupled to the processor.

In another aspect, there is provided a method for assigning signature index values to signatures. The method includes:
separately renumbering a list of available signatures specified in the IE “Available signature” included in the IE “PRACH info” and the IE “PRACH preamble control parameters (for Enhanced Uplink)” contained in the IE “Common E-DCH system info” from signature index 0 to signature index N−1, where N is the number of available signatures, starting with the lowest available signature number and continuing in sequence, in the order of increasing signature numbers; and
for each occurrence in the IE “PRACH preamble control parameters extension list Type 1 (for Enhanced Uplink)”, IE “PRACH preamble control parameters extension list Type 2 (for Enhanced Uplink)”, and IE “PRACH preamble control parameters extension list Type 3 (for Enhanced Uplink)”:
   separately renumbering the list of available signatures specified in the IE “Available signature” included in the IE “PRACH preamble control parameters (for Enhanced Uplink)” from signature index 0 to signature index N−1, where N is the number of available signatures, starting with the lowest available signature number and continuing in sequence, in the order of increasing signature numbers.

As disclosed above, in one aspect there is provided a method for determining a default Enhanced Dedicated Channel, E-DCH, resource index. In some embodiments, the method includes storing a Concurrent Transmission Time Interval, TTI, Partition Index, CTPI, and storing an ordered set of signatures, wherein each signature included in the ordered set is mapped to a default common E-DCH 2 ms TTI resource. The method also includes assigning a signature index value of zero to the first signature included in said ordered set; and for each other signature included in said set, assigning a signature index value to the signature wherein the assigned signature index value is one greater than the signature index value assigned to the immediately preceding signature in said set. The method also includes, for a given signature included in the ordered set, determining the signature index value, SigInd, assigned to the given signature; and for the given signature, determining the default E-DCH resource index mapped to the given signature by calculating one of: a) (SigInd+CTPI) mod Y and b) (SigInd mod (Y−CTPI))+CTPI, where Y is the total number of E-DCH resources configured in the cell for Enhanced Uplink in CELL_FACH state and IDLE mode.

In some embodiments, the ordered set of signatures is a partition 2 or partition 3 signature set. The partition 2 signature set may be defined in a PRACH preamble control parameters extension list Type 2 (for Enhanced Uplink) information element, IE. The partition 3 signature set may be defined in a PRACH preamble control parameters extension list Type 3 (for Enhanced Uplink) information element, IE.

In another aspect there is a method for calculating a default Enhanced Dedicated Channel, E-DCH, resource index. In some embodiments, the method includes receiving a Concurrent Transmission Time Interval, TTI, Partition Index, CTPI. The method also includes calculating (SigInd+CTPI) mod Y or calculating (SigInd mod (Y−CTPI))+CTPI. Y is the total number of E-DCH resources configured in a cell for Enhanced Uplink in CELL_FACH state and IDLE mode, and SigInd is the signature index value of the Nth PRACH preamble signature corresponding to an access indicator, AI, that is configured available in the cell and corresponding to E-DCH transmission for Enhanced Uplink in CELL_FACH state and IDLE mode.

In some embodiments, the above described methods are performed by a wireless communication device. In such embodiments, the given signature may be a signature selected by the wireless communication device for use when performing a random access procedure.

In some embodiments, the above described methods are performed by a base station. In such embodiments, the given signature may be a signature received from a wireless communication device as part of a random access procedure.

In another aspect, the disclosure provides an apparatus for determining a default Enhanced Dedicated Channel, E-DCH, resource index. In some embodiments, the apparatus is adapted to store a Concurrent Transmission Time Interval, TTI, Partition Index, CTPI and also store an ordered set of signatures, wherein each signature included in the ordered set is mapped to a default common E-DCH 2 ms TTI resource. The apparatus is also adapted to assign a signature index value of zero to the first signature included in said ordered set; and for each other signature included in said set, assign a signature index value to the signature wherein the assigned signature index value is one greater than the signature index value assigned to the immediately preceding signature in said set. The apparatus is also adapted to, for a given signature included in the ordered set, determine the signature index value, SigInd, assigned to the given signature; and for the given signature, determine the default E-DCH resource index mapped to the given signature by calculating one of: a) (SigInd+CTPI) mod Y and b) (SigInd mod (Y−CTPI))+CTPI, where Y is the total number of E-DCH resources configured in the cell for Enhanced Uplink in CELL_FACH state and IDLE mode.

In some embodiments, the ordered set of signatures is a partition 2 or partition 3 signature set. The partition 2 signature set may be defined in a PRACH preamble control parameters extension list Type 2 (for Enhanced Uplink) information element, IE. The partition 3 signature set may be defined in a PRACH preamble control parameters extension list Type 3 (for Enhanced Uplink) information element, IE.

In another aspect, the disclosure provides an apparatus for calculating a default Enhanced Dedicated Channel, E-DCH, resource index, the apparatus is adapted to receive a Concurrent Transmission Time Interval, TTI, Partition Index, CTPI. The apparatus is further adapted to calculate (SigInd+CTPI) mod Y or calculate (SigInd mod (Y−CTPI))+CTPI, where Y is the total number of E-DCH resources configured in a cell for Enhanced Uplink in CELL_FACH state and IDLE mode, and SigInd is the signature index value of the Nth PRACH preamble signature corresponding to an access indicator, AI, that is configured available in the cell and corresponding to E-DCH transmission for Enhanced Uplink in CELL_FACH state and IDLE mode.

In some embodiments, the above described apparatus is a wireless communication device. In such embodiments, the given signature may be a signature selected by the wireless communication device for use when performing a random access procedure.

In some embodiments, the above described apparatus is a base station. In such embodiments, the given signature may be a signature received from a wireless communication device as part of a random access procedure.

In another aspect an apparatus is provided, the apparatus includes a data processing system and a data storage system. The data storage system contains instructions executable by the data processing system wherein the apparatus is operative to store a Concurrent Transmission Time Interval, TTI, Partition Index, CTPI; and store an ordered set of signatures, wherein each signature included in the ordered set is mapped to a default common Enhanced Dedicated Channel, E-DCH, 2 ms TTI resource. The apparatus is further operative to assign a signature index value of zero to the first signature included in said ordered set; and for each other signature included in said set, assign a signature index value to the signature wherein the assigned signature index value is one greater than the signature index value assigned to the immediately preceding signature in said set. The apparatus is further operative to, for a given signature included in the ordered set, determine the signature index value, SigInd, assigned to the given signature; and for the given signature, determine the default E-DCH resource index mapped to the given signature by calculating one of: a) (SigInd+CTPI) mod Y and b) (SigInd mod (Y−CTPI))+CTPI, where Y is the total number of E-DCH resources configured in the cell for Enhanced Uplink in CELL_FACH state and IDLE mode.

In some embodiments the ordered set of signatures is a partition 2 or partition 3 signature set. The partition 2 signature set may be defined in a PRACH preamble control parameters extension list Type 2 (for Enhanced Uplink) information element, IE. The partition 3 signature set may be defined in a PRACH preamble control parameters extension list Type 3 (for Enhanced Uplink) information element, IE.

In some embodiments, the apparatus includes a transceiver (1505) coupled to the data processing system.

In some embodiments, the apparatus is a wireless communication device. In such embodiments, the given signature may be a signature selected by the wireless communication device for use when performing a random access procedure.

In some embodiments, the apparatus is a base station. In such embodiments, the given signature may be a signature received from a wireless communication device as part of a random access procedure.

In another aspect, there is provided a wireless communication device, WCD, capable of calculating a default E-DCH resource index. In some embodiments, the WCD includes a processor and a memory unit. The memory unit stores instructions. The instructions are executable by the processor wherein the WCD is operative to store a received Concurrent Transmission Time Interval, TTI, partition Index, CTPI. The WCD is further operative to calculate ((SigInd+CTPI) mod Y) or ((SigInd mod (Y−CTPI))+CTPI), where Y is the total number of E-DCH resources configured in a cell for Enhanced Uplink in CELL_FACH state and IDLE mode, and SigInd is the signature index value of the Nth PRACH preamble signature corresponding to an access indicator, AI, that is configured available in the cell and corresponding to E-DCH transmission for Enhanced Uplink in CELL_FACH state and IDLE mode. In some embodiments, the wireless communication device further comprises an antenna, a transceiver coupled to the antenna and the processor, and a display screen coupled to the processor.

While various aspects and embodiments of the present disclosure have been described above, it should be understood that they have been presented by way of example only, and not limitation. Thus, the breadth and scope of the present disclosure should not be limited by any of the above-described exemplary embodiments. Moreover, any combination of the elements described in this disclosure in all possible variations thereof is encompassed by the disclosure unless otherwise indicated herein or otherwise clearly contradicted by context.

Additionally, while the processes described herein and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A method for determining a default Enhanced Dedicated Channel, E DCH, resource index, comprising:
storing a Concurrent Transmission Time Interval, TTI, Partition Index, CTPI;
storing an ordered set of signatures, wherein each signature included in the ordered set is mapped to a default common E-DCH 2 ms TTI resource;
assigning a signature index value of zero to the first signature included in said ordered set;
for each other signature included in said set, assigning a signature index value to the signature wherein the assigned signature index value is one greater than the signature index value assigned to the immediately preceding signature in said set;
for a given signature included in the ordered set, determining the signature index value, SigInd, assigned to the given signature; and
for the given signature, determining the default E DCH resource index mapped to the given signature by calculating one of: a) (SigInd+CTPI) mod Y and b) (SigInd mod (Y−CTPI))+CTPI, where Y is the total number of E-DCH resources configured in the cell for Enhanced Uplink in CELL_FACH state and IDLE mode.

2. The method of claim 1, wherein said ordered set of signatures is a partition 2 or partition 3 signature set.

3. The method of claim 2, wherein the partition 2 signature set is defined in a PRACH preamble control parameters extension list Type 2 (for Enhanced Uplink) information element, IE.

4. The method of claim 2, wherein the partition 3 signature set is defined in a PRACH preamble control parameters extension list Type 3 (for Enhanced Uplink) information element, IE.

5. A method for calculating a default Enhanced Dedicated Channel, E DCH, resource index, comprising:
receiving a Concurrent Transmission Time Interval, TTI, Partition Index, CTPI; and
calculating (SigInd+CTPI) mod Y or calculating (SigInd mod (Y−CTPI))+CTPI, where Y is the total number of E-DCH resources configured in a cell for Enhanced Uplink in CELL_FACH state and IDLE mode, and SigInd is the signature index value of the Nth PRACH preamble signature corresponding to an access indicator, AI, that is configured available in the cell and corresponding to E-DCH transmission for Enhanced Uplink in CELL_FACH state and IDLE mode.

6. The method of claim 1, wherein the method is performed by a wireless communication device.

7. The method of claim 6, wherein the given signature is a signature selected by the wireless communication device for use when performing a random access procedure.

8. The method of claim 1, wherein the method is performed by a base station.

9. The method of claim 8, wherein the given signature is a signature received from a wireless communication device as part of a random access procedure.

10.-18. (canceled)

19. An apparatus comprising:
a data processing system; and
a data storage system, the data storage system containing instructions executable by the data processing system, which, when executed, cause the apparatus to:
store a Concurrent Transmission Time Interval, TTI, Partition Index, CTPI;
store an ordered set of signatures, wherein each signature included in the ordered set is mapped to a default common Enhanced Dedicated Channel, E-DCH, 2 ms TTI resource;
assign a signature index value of zero to the first signature included in said ordered set;
for each other signature included in said set, assign a signature index value to the signature wherein the assigned signature index value is one greater than the signature index value assigned to the immediately preceding signature in said set;
for a given signature included in the ordered set, determine the signature index value, SigInd, assigned to the given signature; and
for the given signature, determine the default E DCH resource index mapped to the given signature by calculating one of: a) (SigInd+CTPI) mod Y and b) (SigInd mod (Y−CTPI))+CTPI, where Y is the total number of E-DCH resources configured in the cell for Enhanced Uplink in CELL_FACH state and IDLE mode.

20. The apparatus of claim 19, wherein said ordered set of signatures is a partition 2 or partition 3 signature set.

21. The apparatus of claim 20, wherein the partition 2 signature set is defined in a PRACH preamble control parameters extension list Type 2 (for Enhanced Uplink) information element, IE.

22. The apparatus of claim 20, wherein the partition 3 signature set is defined in a PRACH preamble control parameters extension list Type 3 (for Enhanced Uplink) information element, IE.

23. The apparatus of claim 19, wherein the apparatus includes a transceiver coupled to the data processing system.

24. The apparatus of claim 19, wherein the apparatus is a wireless communication device.

25. The apparatus of claim 24, wherein the given signature is a signature selected by the wireless communication device for use when performing a random access procedure.

26. The apparatus of claim 19, wherein the apparatus is a base station.

27. The apparatus of claim 26, wherein the given signature is a signature received from a wireless communication device as part of a random access procedure.

28. A wireless communication device, WCD, capable of calculating a default Enhanced Dedicated Channel, E-DCH, resource index, comprising:
a processor and a memory unit, the memory unit storing instructions executable by the processor which, when executed, cause the WCD to:
store a received Concurrent Transmission Time Interval, TTI, partition Index, CTPI; and
calculate ((SigInd+CTPI) mod Y) or ((SigInd mod (Y−CTPI))+CTPI), where Y is the total number of E-DCH resources configured in a cell for Enhanced Uplink in CELL_FACH state and IDLE mode, and SigInd is the signature index value of the Nth PRACH preamble signature corresponding to an access indicator, AI, that is configured available in the cell and corresponding to E-DCH transmission for Enhanced Uplink in CELL_FACH state and IDLE mode.

29. The wireless communication device of claim 28, wherein the wireless communication device further comprises an antenna, a transceiver coupled to the antenna and the processor, and a display screen coupled to the processor.
